(19) United States
(12) Patent Application Publication
(10) Pub. No.: US 2016/0283897 A1
(43) Pub. Date: Sep. 29, 2016

(54) DAYS OF INVENTORY DETERMINATION BASED ON CONSTRAINTS

(71) Applicant: HEWLETT PACKARD ENTERPRISE DEVELOPMENT LP, Houston, TX (US)

(72) Inventors: Cara J. Curtland, Vancouver, WA (US); Brad D. Wolf, Roseville, CA (US); Jerry Hwang, Cupertino, CA (US); Dave Chang, Vancouver, WA (US); Divya Mangotra, Vancouver, WA (US)

(21) Appl. No.: 15/032,949

(22) PCT Filed: Oct. 31, 2013
(86) PCT No.: PCT/US13/67682

§ 371 Date: Apr. 28, 2016

(51) Int. Cl. G06Q 10/08; G06Q 10/06

(52) U.S. Cl. CPC G06Q 10/087; G06Q 10/0631

(57) ABSTRACT

An inventory management technique includes an inventory target engine to calculate an inventory target for each product of a plurality of products based on a service level designation, a variability parameter and a budgetary constraint.

### BACKGROUND

Supply chain management is tasked with overseeing inventory and stock of products and parts for the successful operation of a business. The management of the inventory, however, may be constrained by several variables and targets determined by the realities of being a business. Some of those variables may include budgetary targets, product priorities, and inventory costs. For supply chain management to fulfill their chartered tasks, the aforementioned constraints may limit their discretion on the maintenance of inventory.

### BRIEF DESCRIPTION OF THE DRAWINGS

For a detailed description of exemplary embodiments of the invention, reference will now be made to the accompanying drawings in which:

FIG. 1 shows a system diagram in accordance with various examples;

FIG. 2 shows an example of a total days of inventory optimization system based on constraints in accordance with various examples;

FIG. 3 shows an illustrative implementation of a total days of inventory optimization system based on constraints in accordance with various examples; and

FIG. 4 shows a method in accordance with various examples.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ”Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Supply chain management concepts may be used to efficiently manage product inventory levels to satisfy a number of factors. These factors may include stock level targets, budgetary constraints, profit margins, product volume, revenue, and cost of sales, to name a few. Some or all of these factors may be used to construct a supply chain philosophy that may ultimately drive the inventory target levels. This enacted philosophy, however, may make certain trade-offs between these factors when target inventory levels are determined. For example, a service level, defined as the percent of time that a customer's request for a product may be satisfied from stock, may be chosen depending on how willing a company may be in not satisfying a customer's request for a product. This may affect stock levels and cost of inventory since a high service level may increase the amount of stock required to be kept, which may directly affect the overall costs to the company. These tradeoffs may be implemented by the supply chain management infrastructure of the company.

Other trade-offs or weights may be assigned to various other variables associated with prioritizing stock levels, such as profit margin, volume, and revenue. Additionally, a products category or strategy may also affect the stock levels, such as new product introduction, a product at the end of its life, targeted advertising campaigns, etc. All such factors may influence target stock levels of individual products and parts. All of these factors and constraints, however, may be used to determine target stock levels, safety stock target levels, and total days of inventory for all products of an enterprise's supply chain. Yet, due to the enterprise's philosophy and marketing strategies, keeping the stock levels and service levels aligned with the budgetary constraints of the supply chain may be difficult.

One technique to determine target stock levels (also referred to as “target days of stock (TDOS)” or “safety stock”) and total days of inventory may be to constrain stock levels to a budgetary constraint while maximizing service levels. This may involve an optimization system to optimize the service levels assigned to a product or category of products based on the budgetary constraint and then calculating the actual inventory targets for each product and location in a supply chain. Further, the optimization system may take into account all forms of stock owned by an enterprise at the time of optimization, which may include in-transit stock, on-order stock, and on-hand stock. The in-transit stock may also be disaggregated into the time period of the transit in which the supplier owns it and the time period that the purchasing entity owns it to be used for inventory calculations. Additionally, the optimization system may also account for variability of the products being used/sold based on either forecast variability or consumption variability.

The inventory targeting technique described herein relates to parts that are stocked to enable an enterprise to satisfy market demand for its products. Each part may be stocked at one or more locations and each location may be part of a set of locations that the enterprise manages as one region. For the purposes of this disclosure, the target stock level calculated for each part will refer to the part at each location in which it is stored. Each location may have a different target stock level.

The optimization system may both perform modeling and simulation along with alternative outcomes before final targets are set. Additionally, the optimization system may continuously update the numbers to track actual versus target. The targets may further be broken up by region and/or time period such as fiscal quarter.

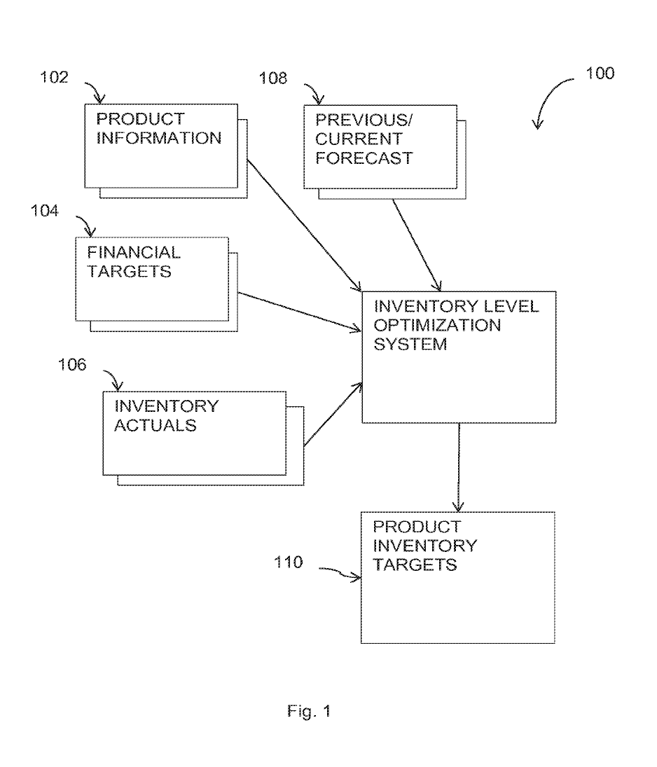

FIG. 1 shows an inventory optimization system 100 in accordance with examples discussed herein. The inputs to the system 100 may include a product information 102, financial targets 104, inventory actuals 106 and previous/current forecast 108. The outputs of the system 100 may include product inventory targets 110. All of the inputs to the system 100 may be contained in a single database or may be compiled from several databases distributed across an organization and connected via a network, such as a wide area network (WAN), a storage area network (SAN), or in various data servers connected to the internet.

The product information 102 may include various attributes and data concerning a plurality of products. The various attributes and data in various combinations may be used by the system 100 in determining inventory and safety stock targets. The various attributes of the plurality of products may include, per product, a point of re-order (POR) value, an assigned category from a previous fiscal quarter, a coefficient of variability based on forecasting and based on consumption. Additional data about the products may include forecast and consumption demands, delivery times for each product and an associated variability in the delivery times, and other product information (number, line, location, platform, etc.).

The financial targets 104 may include budgetary information for the supply chain, such as quarterly amounts (or other time frames) for both strategic and structural stock. Strategic stock is extra stock to be ordered to account for uncertainty in consumption and delivery while structural stock is what is currently on hand and in-transit. These values may have amounts associated with a previous fiscal quarter and future fiscal quarters. Other financial information may include cost of services/cost of goods sold, and a target total days of inventory (TOI). The TOI value is a number of days the business may continue to operate based on the on-hand inventory, in-transit inventory, and on-order inventory. This target is one way to quickly assess the amount of cash tied up in inventory. The TOI may be used to determine a budget goal to use as the constraint for inventory management purposes.

The inventory actuals 106 may include the amount of stock (in-transit, on-hand, and on-order) for each product in the supply chain. These numbers may affect the optimization calculations of the system 100 because actual numbers may vary from previous inventory target plans. The numbers may vary due to variations in delivery times and delivery amounts. The delivery amounts, amount of product per shipment, may vary due to variations in lot sizes vis-a-vis target amounts. For example, if a previous inventory target required the placement of an order but the actually quantity needed to meet the target was less than an available lot size from a supplier, then the whole lot size may need to be ordered to meet the target. This situation, however, leads to more of that product on hand than was targeted, which may affect subsequent inventory operations for that product. Hence, there may always be a difference between modeled/simulated targets and actuals. Further, the in-transit stock may only be owned by the Enterprise for a portion of the time for delivery. As such, the inventory actuals may only account for the time the inventory is actually owned so to predict a more accurate budget.

The previous/current forecast 108 may include the inventory and service level targets from a previous calculation by the system 100. The previous/current forecast 108 data may include the service level targets, inventory targets and safety inventory targets from a previous fiscal quarter, or other fiscal timeframe. This information may be used by the system 100 as one way to track actuals against forecasts.

The output of the optimization system 100 may be a safety stock target (target days of inventory) that accounts for what is on-hand and in-transit but to also account for variability in demand and in supply. The safety stock target may be based on the service level, such that the higher the service level the higher the amount of safety stock that may be ordered. A service level of 50%, for example, may not require any safety stock whereas service levels above 50% may require progressively more safety stock.

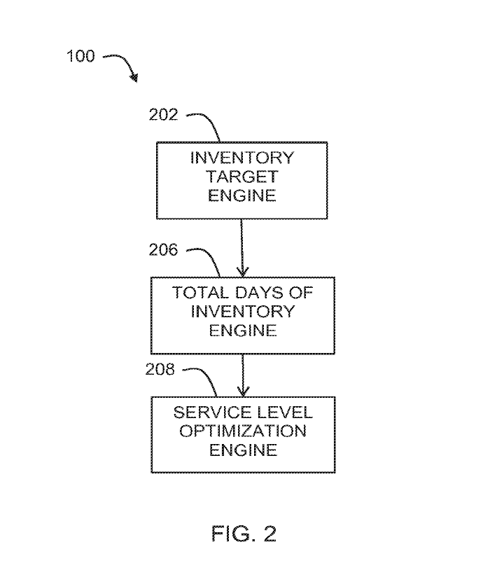

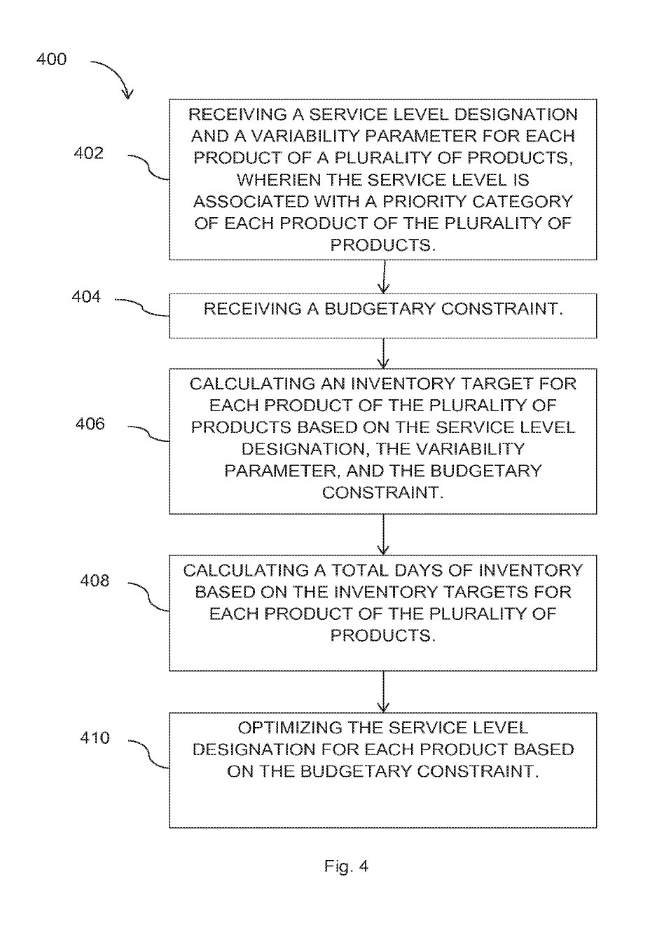

FIG. 2 illustrates an example of the inventory optimization system 100. The illustrative system 100 of FIG. 2 includes various engines that provide the system with the functionality described herein. The system 100 may include an inventory target engine 202, a total days of inventory engine 204, and a service level optimization engine 206. Although the various engines 202-206 are shown as separate engines in FIG. 2, in other implementations, the functionality of all or a subset of the engines 202-206 may be implemented as a single engine. The functionality implemented on these engines will be further explained below with regard to FIG. 4.

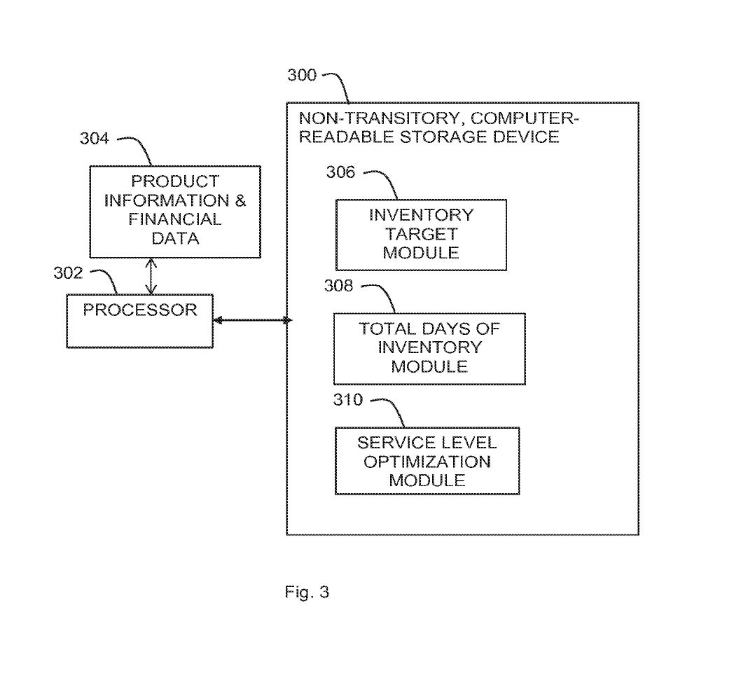

In some examples of the system 100, each engine 202-206 may be implemented as a processor executing software. FIG. 3, for example, shows one suitable example in which a processor 302 is coupled to a non-transitory, computer-readable storage device 300. The non-transitory, computer-readable storage device 300 may be implemented as volatile storage (e.g., random access memory), non-volatile storage (e.g., hard disk drive, optical storage, solid-state storage, etc.) or combinations of various types of volatile and/or non-volatile storage.

The non-transitory, computer-readable storage device 300 is shown in FIG. 3 to include a software module that corresponds functionally to each of the engines of FIG. 2. The software modules may include an inventory target module 306, a total days of inventory module 308, and a service level optimization module 310. Each engine of FIG. 2 may be implemented as the processor 302 executing the corresponding software module of FIG. 3.

The distinction among the various engines 202-206 and among the software modules 306-310 is made herein for ease of explanation. In some implementations, however, the functionality of two or more of the engines/modules may be combined together into a single engine/module. Further, the functionality described herein as being attributed to each engine 202-208 is applicable to the software module corresponding to each such engine, and the functionality described herein as being performed by a given module is applicable as well as to the corresponding engine.

A target days of stock (TDOS) level or an inventory target for a product may be influenced by many factors. These factors may include a replenishment lead time (RLT), otherwise termed a delivery lead time, a coefficient of variation of cumulative forecast error over RLT (CoVcFE) (a variability parameter), and a value (k) based on a chosen service level. The value of k is based on a chosen service level and may be a z-value for a standard normal distribution. The RLT (e.g., measured in days) may include the entire order-to-delivery period. The value CoVcFE is the coefficient of variation of cumulative forecast error over RLT. The standard normal distribution may also define a relationship between the percentages of RLT periods with the chosen service level demand.

The CoVcFE parameter may describe the variation in the lead time for obtaining a product for use. Each product an Enterprise consumes may have a different lead time. The CoVcFE parameter may be based on forecasting the lead times for a product and the error associated with the forecasts. Alternatively, a coefficient of variation of cumulative consumption over RLT (CoVccoNs) parameter may be used in place of the CoVcFE parameter, which would be based on a past consumption-based forecast error of the product. In general, COV is the standard deviation of forecast error terms divided by the average forecast. Such a consumption based forecast error may be derived from prior consumption data. In some implementations, TDOS may be computed as:

TDOS=k*RLT*CoVcFE

The value CoVcFE in the equation above may be replaced with CoVccoNs when computing consumption-based TDOS.

The RLT may be measured in days and may include an entire order-to-delivery period, not just a transit time form supplier to an Enterprise location. The RLT may include its own confidence, such as 90%. The confidence, however, may change with supplier and or product based on experience. Alternatively, RLT may be replaced with ERLT (effective replenishment lead time), which may include some additional lead time. The ERLT, also measured in days, may include the entire order-to-delivery period and an additional effective lead time due to limited supplier response capability outside of the quoted lead time (the RLT). The additional lead time may be calculated based on the product's CoV and any known supplier response parameters or factory operating guidelines.

The computation of the TDOS value for a product may be, for example, the product of the values the k, RLT and CoVcFE. First, a k value may be determined for a given service level percentage and may represent the portion of the standard normal distribution of errors that is covered by the safety stock. For example, a service level of 90% may lead to a k value of 1.28. Second, the standard normal distribution may be scaled based on the RLT (or the ERLT) and the CoV to obtain the TDOS needed to cover the desired service level.

The total days of inventory value may be an aggregate value of stock based on all products that give a single number on how long the Enterprise may operate based on the amount of stock on-hand, in-transit, and on-order. The total days of inventory may also be a target value included with the financial targets, which may be a constraint for the TDOS and safety stock computations.

Once the TDOS value for each product has been calculated, a monetary value for that target level may be computed. The monetary value may be the product of the unit price and the target inventory number. After a monetary value has been computed for each of the products, a total cost of the inventory target may be calculated based on all of the products. This composite value may then be compared to the budgetary constraint. Based on that comparison, the TDOS values may be changed to meet or come under that budgetary constraint. The TDOS values may be changed by varying the service levels associated with each of the product categories.

The inventory optimization system 100 implements a technique to optimize the service levels assigned to each of the product categories under the same budgetary constraint. This optimization may be performed by the processor 302 executing the service level optimization module 310 or by the service level optimization engine 208. The various product categories may be automatically optimized by the optimization module 310 based on static and dynamic values assigned to the categories and then changing the service level values to meet the budget. For example, using five product categories A, B, C, D and X, a static service level may be assigned to categories D and X, 95% and 50%, respectively, and relative or dynamic values may be assigned to B and C based on A. The dynamic values may be to keep B 5% less than A and C 10% less than A. Then, when the service level optimization engine 208 operates, the five service levels A, B, C, D, and X may be applied to the products to calculate a total cost of inventory based on the new targets and compared to the budget. The service level optimization engine 208 may begin at a maximum value for A.

If the budget is exceeded, then category A may be reduced, which automatically causes B and C to reduce while D and X remain the same. The function is performed again and compared to the budget. This iterative recursive process runs until the budget is not exceeded. At that point, the service levels may be optimized to meet the budget.

Further, the inventory optimization system 100 may perform optimization based on the full Enterprise budget or on a subset of that full budget. The full budget may be broken down by a specific time period and/or a geographic region. The optimization system 100 may be performed on a single geographic region for a time a horizon, e.g., a number of time periods such as fiscal quarters, or on the full budget for a specific time period. For example, the optimization system 100 may select or parse out the budget and part numbers and locations associated with a specific geographic region along with the service levels and categories assigned to each part number for that region and then perform the optimization functions for that region using the budget numbers and parts-location combinations associated with that region. The optimization system 100 may then change to a different region and the new region's associated budget constraint and parts list. The optimization system 100 may then be able to aggregate all of the calculated inventory targets for each region to give the overall inventory optimization levels.

Stated another way, the full budget may be an aggregate budget for a number of different geographical regions. Each region would have an associated budget in which to constrain to. The plurality of parts for each region would have an associated service level and assigned category that may be different for each geographical region. As such, the optimization system 100 may be performed for each geographical region individually using each region's unique service levels and category assignments. The optimized solution might have a different service level for each product category (e.g., A, B, C, D, etc.) for each region and time horizon.

FIG. 4 shows a flow diagram of a method 400 for implementing the inventory optimization system 100. The various operations depicted in FIG. 4 may be performed in the order shown or in a different order and two or more of the operations may be performed in parallel instead of serially. Additionally, the steps of the method 400 may be performed by one or more of the various engines 202-206 of FIG. 2 and/or the various software modules 306-310 of FIG. 3.

The method 400 begins at step 402 with receiving a service level designation and a variability parameter for each product of a plurality of products. As noted above, the service level may be associated with a priority category of each product of the plurality of products. The service level designations may be received by the processor 30 from the product information and financial data 304 of FIG. 3. The product information and financial data 304 may correspond to all or a subset of the components 102-108. The method 400 may then continue at step 404 with receiving a budgetary constraint. The budgetary constraint may be received by the processor 302 from the same database containing the product information or it may be stored in a separate database.

The method 400 may then continue at step 406 with calculating an inventory target for each product of the plurality of products based on the service level, the variability parameter and the budgetary constraint. The inventory target, which may be the TDOS, may be computed by the processor 302 executing the inventory target module 306 or by the inventory target engine 202. The inventory target module may calculate the TDOS for each product constrained by the budgetary constraint so that the inventory target may be optimized under the budgetary constraint.

The method 400 may then end at step 408 (or continue on to step 410) with calculating a total days of inventory based on the inventory targets for each product of the plurality of products. The total days of inventory may be an aggregate of all inventory in stock (on-hand, in-transit, and on-order) for each product and may indicate how long an Enterprise may operate under that amount of inventory. Additionally, the total days of inventory may also be a target value indicated by the financial data.

Alternatively, if the method 400 includes the step 410, the method 400 may also optimize the service level designation for each product based on the budgetary constraints. The optimization of the service level in light of the budget may be performed by the service level optimization engine 206 or the processor 302 executing the service level optimization module 310. In either instance, the service levels may be optimized in accordance to either a static or dynamic value. The static value may be a set percentage that is to be maintained whereas the dynamic values may vary in accordance to a set relationship between the categories. Implementing a recursive, iterative linear function, the service levels are changed, which changes the TDOS values, which in turn generate a new stock cost. This stock cost is then compared to the budget. If the budget is exceeded, then the dynamic service levels are reduced and the values and comparisons recomputed. This process may continue to run until the budget is not exceeded, which results in service levels optimized to the budget.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method for determining safety inventory targets for a product at a location, comprising:
receiving, by at least one processor, a replenishment lead time, a service level designation and a variability parameter for each product and location of a plurality of products and locations, wherein the service level is associated with a priority category;
receiving, by the at least one processor, a budgetary constraint; and
calculating, by the at least one processor, an inventory target for each product and location of the plurality of products and locations based on the replenishment lead time, service level designation, the variability parameter, and the budgetary constraint.

2. The method of claim 1, further comprising:
calculating, by the at least one processor, a total days of inventory based on the inventory targets for each product of the plurality of products.

3. The method of claim 1, further comprising:
optimizing, by the at least one processor, the service level designation for each product based on the budgetary constraint.

4. The method of claim 3, wherein the service level designation for each product may be optimized based on static values and dynamic relations between service level categories.

5. The method of claim 1, wherein the inventory target for each product of the plurality of products takes into account strategic stock and structural stock.

6. A system, comprising:
an inventory target engine to calculate an inventory target for each product of a plurality of products based on a service level designation, a variability parameter and a budgetary constraint.

7. The system of claim 6, further comprising a total days of inventory engine to calculate a total days of inventory for an aggregate of all of the products of the plurality of products based on the inventory targets for each product of the plurality of products, wherein the total days of inventory represents a number of days that a business can continue to operate based on on-hand inventory, in-transit inventory, and on-order inventory.

8. The system of claim 6, further comprising an optimization engine to optimize the service level for each product based on the budgetary constraint.

9. The system of claim 8, wherein the service level designation for each product is based on a product category.

10. The system of claim 6, wherein the variability parameter is based on a forecast error coefficient of variability.

11. A non-transitory, computer-readable storage medium containing code that when executed by at least one processor, causes the at least one processor to:
receive a service level designation and a variability parameter for each product of a plurality of products, wherein the service level is associated with a priority category of each product of the plurality of products;
receive a budgetary constraint, wherein the budgetary constraint is an aggregate of a plurality of geographical regions and time periods; and
set an inventory target for each product of the plurality of products based on the service level designation, the variability parameter, and the budgetary constraint.

12. The non-transitory, computer-readable storage medium of claim 11, wherein the code further causes the at least one processor to set the inventory target for each product of the plurality of products and for each location of the plurality of products for a different geographical region of the plurality of geographical regions.

13. The non-transitory, computer-readable storage medium of claim 11, wherein the inventory target for each product of the plurality of products is further based on a total amount of inventory for each product, wherein the total amount of product includes on-order stock, in-transit stock and on-hand stock.

14. The non-transitory, computer-readable storage medium of claim 11, wherein the code when executed further causes the at least one processor to calculate a monetary value for the plurality of products based on the inventory target.

15. The non-transitory, computer-readable storage medium of claim 11, wherein the code when executed further causes the at least one processor to optimize the service level for each product based on a relationship of a priority category assigned to each product.

16. The non-transitory, computer-readable storage medium of claim 11, wherein the variability parameter is based on a forecast error coefficient of variability.

17. The method of claim 1, wherein the variability parameter is based on a forecast error coefficient of variability.

18. The system of claim 6, wherein the service level is associated with a priority category.

19. The system of claim 6, wherein the inventory target engine to receive the budgetary constraint.

20. The system of claim 6, wherein the inventory target engine to receive a replenishment lead time, the service level designation, and the variability parameter for each product.
